(19) United States
(12) Patent Application Publication
(10) Pub. No.: US 2024/0112236 A1
(43) Pub. Date: Apr. 4, 2024

(54) INFORMATION PROCESSING DEVICE, INFORMATION PROCESSING METHOD, AND COMPUTER-READABLE STORAGE MEDIUM STORING PROGRAM

(71) Applicant: RAKUTEN GROUP, INC., Tokyo (JP)

(72) Inventors: Takashi TOMOOKA, Tokyo (JP); Mitsuru NAKAZAWA, Tokyo (JP)

(73) Assignee: RAKUTEN GROUP, INC., Tokyo (JP)

(21) Appl. No.: 18/474,771

(22) Filed: Sep. 26, 2023

(30) Foreign Application Priority Data
Sep. 29, 2022 (JP) 2022-156853

(51) Int. Cl. G06Q 30/0601; G06F 16/901; G06F 16/906

(52) U.S. Cl. CPC G06Q 30/0629; G06F 16/901; G06F 16/906

(57) ABSTRACT

An information processing device used for an electronic commerce platform includes one or more processors and one or more memories. At least one of the memories stores item data related to items registered in the electronic commerce platform. The item data includes data sets. The data sets each include data fields registered for one of the items. The data fields each include item information related to the one of the items. The processor is configured to execute an indexing process for one or more pieces of item information to obtain an index used to compare the one or more pieces of item information with each other.

### BACKGROUND

### 1. Field

The present disclosure relates to an information processing device, an information processing method, and a computer-readable storage medium storing a program.

### 2. Description of Related Art

Japanese Laid-Open Patent Publication No. 2019-28544 discloses an example of an electronic commerce platform where sellers and purchasers can carry out their business transactions. Generally, a seller can register multiple pieces of item information for one item in the electronic commerce platform. Examples of the item information include the type, description, or image of an item.

Typically, purchasers consider which items to purchase by comparing similar items based on the registered item information. At times, the registered item information can vary depending on the item, and there can also be inconsistencies among multiple pieces of registered item information. Unclear registered information can be found and improved by manual detailed checks. Nevertheless, checking the vast volume of registered data manually is a difficult task. Thus, it is desired to establish a method for checking registered information through automated processing.

An object of the present disclosure is to provide an information processing device, an information processing method, and a computer-readable storage medium storing a program that are capable of checking whether item information related to items is unclear through automated processing.

### SUMMARY

This Summary is provided to introduce a selection of concepts in a simplified form that are further described below in the Detailed Description. This Summary is not intended to identify key characteristics or essential characteristics of the claimed subject matter, nor is it intended to be used as an aid in determining the scope of the claimed subject matter.

An information processing device according to an aspect of the present disclosure is used for an electronic commerce platform. The information processing device includes one or more processors and one or more memories. At least one of the one or more memories store item data related to items registered in the electronic commerce platform. The item data includes data sets. The data sets each include data fields registered for one of the items. The data fields each include item information related to the one of the items. At least one of the one or more processors is configured to execute an indexing process for one or more pieces of item information to obtain an index used to compare the one or more pieces of item information with each other.

An information processing method according to an aspect of the present disclosure is executed by an information processing device used in an electronic commerce platform. The information processing method includes obtaining item data related to items registered in the electronic commerce platform. The item data includes data sets. The data sets each include data fields registered for one of the items. The data fields each include item information related to the one of the items. The information processing method further includes executing an indexing process for one or more pieces of item information to obtain an index used to compare the one or more pieces of item information with each other.

A computer-readable storage medium according to an aspect of the present disclosure stores a program. The program is executed by an information processing device used in an electronic commerce platform. The program is configured to cause one or more computers to obtain item data related to items registered in the electronic commerce platform. The item data includes data sets. The data sets each include data fields registered for one of the items. The data fields each include item information related to the one of the items. The program is further configured to cause the computers to execute an indexing process for one or more pieces of item information to obtain an index used to compare the one or more pieces of item information with each other.

Other features and aspects will be apparent from the following detailed description, the drawings, and the claims.

### BRIEF DESCRIPTION OF DRAWINGS

FIG. 1 is a diagram showing the configuration of a system including an information processing device according to an embodiment.

FIG. 2 is a diagram showing an example of the item data stored in the information processing device of FIG. 1.

FIG. 3 is a diagram showing an example of an item screen in the embodiment.

FIG. 4 is a diagram illustrating a fifth example of the indexing process executed by the information processing device of FIG. 1.

FIG. 5 is a diagram illustrating a sixth example of the indexing process executed by the information processing device of FIG. 1.

FIG. 6 is a diagram illustrating a seventh example of the indexing process executed by the information processing device of FIG. 1.

FIG. 7 is a flowchart illustrating an example of the indexing process executed by the information processing device of FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED INVENTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

Examples of an information processing device, an information processing method, and a computer-readable storage medium storing a program according to the present disclosure will now be described with reference to the drawings. The scope of the present disclosure is defined not by the detailed description but by the claims and their equivalents, and all variations within the scope of the claims and their equivalents are to be construed as being included in the disclosure.

Information Processing System

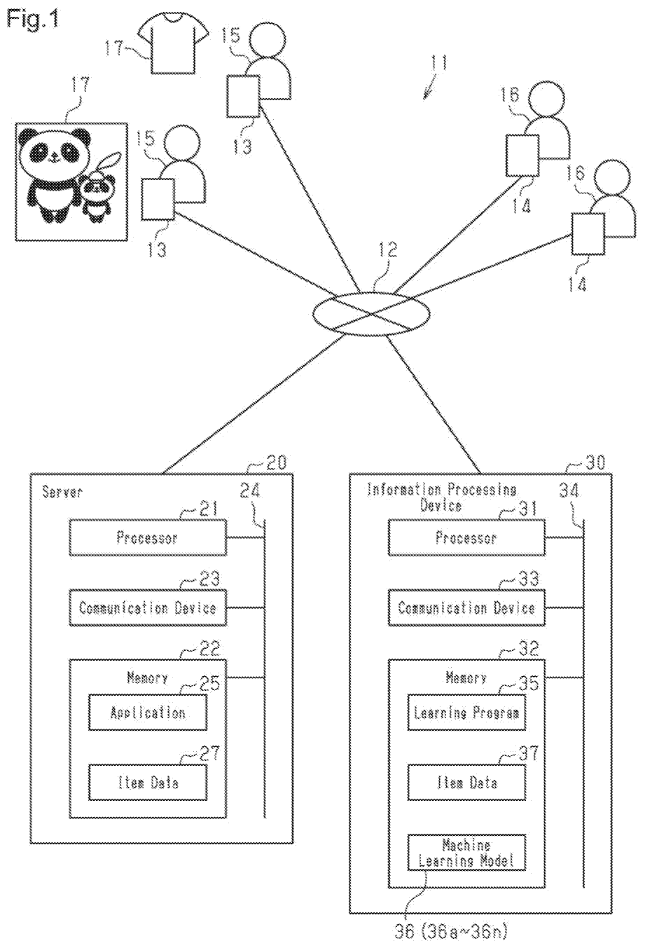

FIG. 1 shows an example of an information processing system 11 according to an electronic commerce platform. The information processing system 11 includes a server 20 that provides a commerce website for items 17, and an information processing device 30 used in the electronic commerce platform. The server 20 and the information processing device 30 communicate with one or more seller terminals 13 and one or more purchaser terminals 14 via a network 12. The information processing device 30 may be integrated with the server 20. In this case, the server 20 has the functions of the information processing device 30.

The network 12 includes, for example, the Internet, a wide area network (WAN), a local area network (LAN), a provider terminal, a wireless communication network, a wireless base station, and a dedicated line. All the combinations of the devices shown in FIG. 1 do not necessarily have to be communicable with one another. The network 12 may partially include a local network.

The seller terminals 13 and the purchaser terminals 14 are, for example, smartphones, personal computers, or tablets. Each seller terminal 13 is operated by a seller 15. Each purchaser terminal 14 is operated by a purchaser 16. The seller 15 of items 17 and the purchaser 16 of items 17 are users of the commerce website.

The server 20 includes one or more processors 21, one or more memories 22, a communication device 23, and a communication bus 24 that is used to connect these elements to one another. The communication device 23 enables communication with other devices (e.g., the seller terminal 13, the purchaser terminal 14, and the information processing device 30) via the network 12. The memory 22 stores item data 27 and an application 25 that is used to run the commerce website.

The server 20 receives item information, which will be described in detail below, from the seller terminal 13. The received item information is stored in the memory 22 as the item data 27 of an item 17 traded on the commerce website. When the item data 27 is stored in this manner, the item 17 associated with the item data 27 is registered in the commerce website (electronic commerce platform). The item data 27 is registered information related to the item 17 registered in the commerce website.

The purchasers 16 may consider which items 17 to purchase by comparing similar items 17 based on the registered item information. Thus, the application 25 may have a search function for searching for the items 17 that are in stock based on various conditions.

The information processing device 30 includes one or more processors 31, one or more memories 32, a communication device 33, and a communication bus 34 that is used to connect these elements to one another. The communication device 33 enables communication with, for example, the server 20 via the network 12. One or more learning programs 35 used for machine learning and one or more generated machine learning models 36 are stored in the memory 32. Examples of the machine learning model 36 may include one or more of machine learning models 36a to 36n, which will be described later. Instead, the machine learning model 36 may be a machine learning model that can obtain a target result.

The information processing device 30 obtains the item data 27 from the server 20 on a regular basis, at a specific time, or in real time. As a result, the item data 27 related to items 17 registered in the electronic commerce platform is stored in the memory 32 as item data 37. The information processing device 30 may obtain the item data 27 via a component other than the server 20, such as a computer, a server, or a storage. The data stored in the information processing device 30 is referred to as the item data 37 to be distinguished from the item data 27, which is updated at any time in the server 20.

Each of the processor 21 and the processor 31 includes an arithmetic unit such as a CPU, a GPU, and a TPU. The processor 21 and the processor 31 are processing circuitry configured to execute various types of software processing. The processing circuitry may include a dedicated hardware circuit (e.g. ASIC) used to process at least some of the software processing. That is, the software processing simply needs to be executed by processing circuitry that includes at least one of a set of one or more software processing circuits and a set of one or more dedicated hardware circuits.

The memories 22, 32 are computer-readable media. The memories 22, 32 may include, for example, a non-transitory storage media such as a random access memory (RAM), a hard disk drive (HDD), a flash memory, and a read-only memory (ROM). The processors 21, 31 execute a series of instructions included in the program stored in the memories 22, 32, respectively, upon a given signal or upon satisfaction of a predetermined condition.

Commerce Website

The commerce website provided by the server 20 will now be described. The commerce website is provided to mediate transactions between the seller 15 and the purchaser 16. For example, the application 25 causes the processor 21 to execute a process that stores, as the item data 27, item information related to items 17 received from one or more seller terminals 13 in the memory 22.

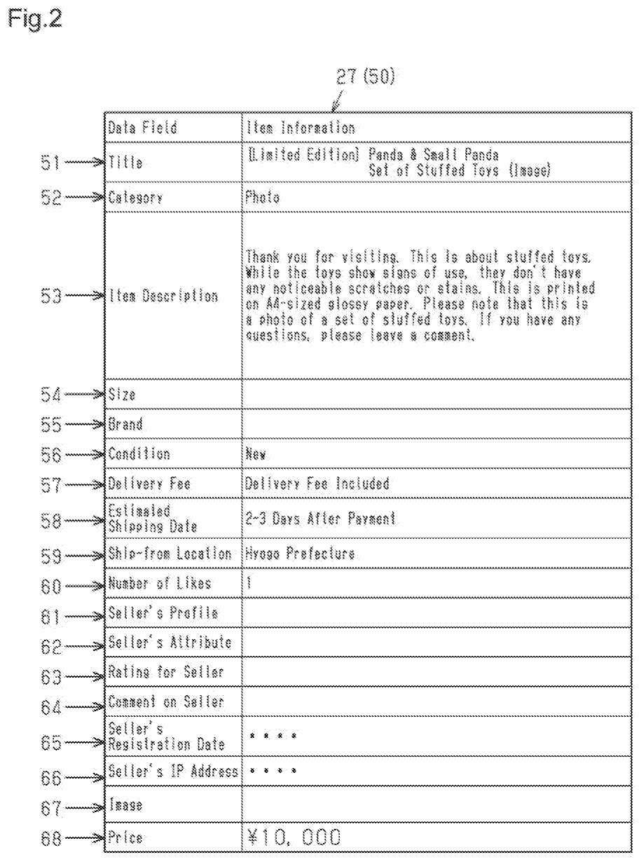

As shown in FIG. 2, the item data 27 includes data sets 50 registered for each item 17. Each data set 50 includes data fields having different types of data. Examples of the data fields include a title 51, a category 52, a description 53, a size 54, a brand 55, a condition 56, delivery fee information 57, a shipping date 58, a ship-from location 59, the number of likes 60, a profile 61 of the seller, an attribute 62 of the seller, a rating 63 for the seller, a comment 64 on the seller, a registration date 65 of the seller, an IP address 66 of the seller, an image 67, and a price 68. However, the data fields are not limited to these elements. For example, the data fields may include audio data, instead of or in addition to the image 67.

Each data field includes item information related to one item 17. Each data set 50 includes at least one piece of item information among data fields. Types of data included in the data fields may be different from each other. The type of data may be one of an attribute and an attribute value for the attribute, a character string (text), an image, and a numerical value. Hereinafter, “an attribute and an attribute value for the attribute” may be simply referred to as an “attribute:attribute value.”

For example, the data types of the category 52, size 54, brand 55, delivery fee information 57, shipping date 58, ship-from location 59, and seller's attribute 62 may be “attribute:attribute value.” The category 52 and the ship-from location 59 may be set to be selected from predefined divisions. The division of the ship-from location 59 is, for example, an administrative division such as a prefecture.

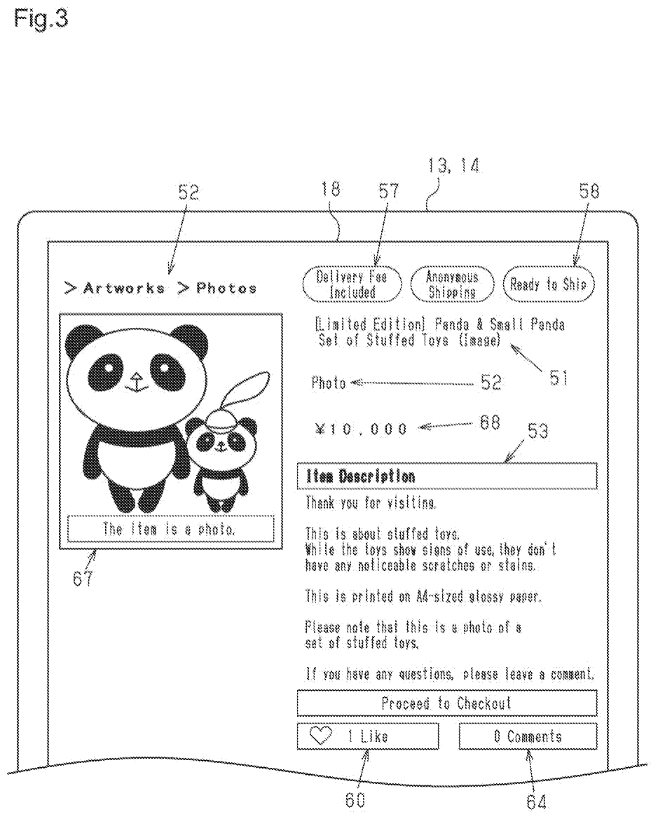

As shown in FIG. 3, the type of data of the title 51, the description 53, the condition 56, the profile 61 of the seller, and the comment 64 on the seller may be a character string. The character string may include sentences. The condition 56 indicates a use condition such as “unused,” “new,” or “no noticeable scratch or stain.” The type of data of the image 67 is an image, and the image may include a moving image. As shown in FIG. 3, the image 67 may be a still image including characters (“The item is a photo.” in FIG. 3), or may be a moving image including audio data. The type of data for the number of likes 60, the rating 63 for the seller, and the price 68 may be numerical.

The title 51 may include one or more pieces of information indicating attributes (for example, the name, brand name, size, and color) of a target. The title 51 may be, for example, a relatively long character string including all of the name, the brand name, the size, and the color. In addition, the title 51 may include, for example, an advertising text for sales promotion, which is not an attribute of the item 17. In this case, the title 51 may be, for example, “limited,” “free shipping,” or “recommended.”

There may be character limits for the title 51 and the description 53. The character limit for the title 51 may be less than the character limit for the description 53. The title 51 is also identification information of the item 17. Thus, instead of the title 51, the identification information (e.g., the name of the item 17) may be included as a data field.

The application 25 causes the processor 21 to execute a process that displays the registered item data 37 on an item screen 18 as shown in FIG. 3. The item screen 18 has a display region in which each data field is displayed. The item screen 18 is displayed on the display of a user terminal (e.g., the seller terminal 13 or the purchaser terminal 14) upon a request from a user (e.g., the seller 15 or the purchaser 16).

Indexing Process

The processor 31 is configured to execute an indexing process for one or more pieces of item information to obtain an index 71 that is used to compare the one or more pieces of item information. At least part of the indexing process may be executed using one or more machine learning models 36.

When two indices 71 are obtained based on item information included in two of data fields, the two data fields may be referred to as a first data field and a second data field, respectively. That is, “first,” “second,” “third,” and the like do not indicate a specific object (data field, item information, index, or the like). Instead, they are ordinal numbers used to identify data fields. The number of ordinal numbers is not limited to two and may be changed to three or more. In this case, the item information included in the first data field may be referred to as first item information, and the item information included in the second data field may be referred to as second item information. In addition, the index 71 obtained based on the first item information may be referred to as a first index 71a, and the index 71 obtained based on the second item information may be referred to as a second index 71b. In this case, the indexing process includes obtaining the first index 71a related to one item 17 based on the first item information and obtaining the second index 71b related to that item 17 based on the second item information. The processor 31 is configured to execute a comparison process that compares indices 71 (e.g., the first index 71a and the second index 71b).

The index 71 is, for example, a category defined for classifying the items 17. In this case, obtaining the index 71 includes classifying one item 17 based on item information. The item 17 may be classified so as to correspond to one of the categories 52, which are one type of the data fields. Alternatively, the item 17 may be classified as a classification different from the category 52, which is included in the data fields.

The item 17 may be classified based on item information using a known machine learning model 36a. For example, the result of classification (index 71) may be obtained by inputting a character string to a convolutional neural network (CNN) or bidirectional encoder representations from transformers (BERT) for natural language processing (NLP) and solving a classification task. Similarly, the result of classification (index 71) can be obtained by inputting an image to a machine learning model 36b (e.g., CNN for image processing) and solving a decomposition task.

The indexing process may include obtaining two or more classification results by classifying one item 17 two or more times based on different types of information. For instance, in a first example, when the category 52 includes a doll and a photo, obtaining the first index 71a is classifying the item 17 as a doll based on the description 53, which is the first data field, and obtaining the second index 71b is classifying the item 17 as a photo based on the image 67, which is the second data field.

The processor 31 may be configured to execute the comparison process that compares such two or more classification results and then execute an identification process based on the comparison result. The identification process may include identifying the item information registered for one item 17 (at least the item information used for classification) as unclear when two or more classification results do not match each other, and identifying the category of the item 17 based on the classification results when two or more classification results match each other. The match of comparison results is not limited to an exact match. Depending on the type of the index 71, the match only needs to occur within a range that satisfies a specific condition (for example, a threshold value condition).

In the first example, when the first index 71a (the first classification result) is a doll and the second index 71b (the second classification result) is a photo, whether the item 17 is a doll or a photo is identified as unclear. Such ambiguity may occur when there is an error in the registered item information or when incorrect information is registered.

When all of the indices 71 show the same classification result (for example, a doll), the classification result is highly likely to be correct. Thus, the category of the item 17 may be identified as a doll based on the classification result.

In a simpler second example, the first index 71a may be set to the category 52 serving as item information, and the first index 71a may be compared with the second index 71b showing the classification result obtained from other item information. In this case, the processor 31 may execute the indexing process for one piece of item information in order to compare the two pieces of item information. The processor 31 may be configured to execute the identification process based on two or more indices 71 (e.g., the first index 71a and the second index 71b). The identification process includes identifying the item information registered for one item 17 as unclear when two or more indices 71 do not match each other, and identifying the category 52 of that item 17 when two or more indices 71 match each other based on the matched indices 71.

Registered information becomes clearer as the number of matched classification results increases. Thus, the identification process may be executed based on three or more indices 71 (three or more classification results). In this case, the registered information may be identified as clear when all the indices 71 match each other or when the indices 71 may match each other within a range that satisfies a specific condition. For example, when the obtained index 71 can be identified as invalid or inappropriate, the identification process may be executed based on the indices 71 other than the obtained index 71.

The index 71 may be the probability that the item 17 corresponds to a certain category 52. In this case, the indexing process may include calculating the probability that one item 17 corresponds to a certain category 52. Then, the processor 31 may determine that the item 17 corresponds to a certain category 52 when the probability that the item 17 corresponds to the category 52 is greater than or equal to a predetermined threshold value.

The indexing process may include generating processed information by processing item information prior to classification. In this case, obtaining the index 71 related to one item 17 based on the item information includes obtaining the index 71 based on the processed information. For example, the indexing process may include a process that classifies the item 17 based on the processed information.

The indexing process may include obtaining the first index 71a related to one item 17 based on one piece of item information, generating processed information by processing the item information, and obtaining the second index 71b related to that item 17 based on the processed information. For instance, in a third example, the first index 71a is obtained by classifying the item 17 as a doll based on the description 53 (original text). Further, a processed sentence obtained by processing that description 53 is generated as processed information. Then, the second index 71b is obtained by classifying that item 17 as a doll based on the processed sentence. In this case, the processor 31 is configured to execute the comparison process that compares the first index 71a with the second index 71b and the identification process.

When the first index 71a is a doll and the second index 71b is also a doll, the item 17 is identified as a doll. When two or more indices 71 are different from each other, the registered item information is identified as unclear. Such processing is particularly effective when the description 53 is relatively long, when there is no image 67, when the image 67 is unclear, or when the number of registered data fields is relatively small. For example, when there is no image 67, the content of the item 17 needs to be judged from other item information such as the description 53. However, if the description 53 is relatively long, the purchaser 16 may skip or misread the content.

Processing item information may include one or more of encoding the item information, summarizing a character string that indicates the item information, processing an image that indicates the item information, extracting a portion from the item information, and converting audio data into a character string (e.g., “This item is not a stuffed toy.”). For instance, in the third example, a summary of the description 53 may be used as the processed information.

Character strings can be summarized using, for example, a NLP model. Character strings may be converted from audio data or may be included in an image. The summarization may be extractive summarization, abstractive summarization, or a combination thereof.

An extractive summarization model is configured to generate a summary by extracting an important portion from a text. For instance, the input description 53 is divided into portions (e.g., sentences) using a CNN, and a classification problem of whether each of the divided portions is important is solved. Thus, a distributed representation of each portion is obtained. Then, the portions classified as important are arranged to generate a summary. The summary created in this manner is a patchwork of excerpts taken from the original description 53, or a text where parts of the original description 53 have been deleted.

Alternatively, the importance of the distributed representation of each portion obtained by a CNN may be evaluated using another model (e.g., a sequence-to-sequence model). In this case, a summary is generated by arranging the portions evaluated as important. In addition, a summary may be generated with an extractive summarization model that uses a pre-trained machine learning model 36d such as, BERT or Efficiently Learning an Encoder that Classifies Token Replacements Accurately (ELECTRA).

An abstractive summarization model is configured to generate new sentences (summary) from the original text (e.g., description 53). For example, a sequence-to-sequence model may be used. Alternatively, an abstractive summarization model using a pre-trained machine learning model 36e (e.g., BERT or ELECTRA) may be used. As another option, a machine learning model 36f in which extractive summarization and abstractive summarization are mixed may be used.

In order to train or fine-tune such a model, data may be labeled. For instance, when a characteristic word is included in each category (e.g., when the word “photo” is included in a sentence in which the category is a card), the sentence may be used as correct answer data. Thus, a machine learning model 36g for summarization can be trained or fine-tuned according to the category. Alternatively, a word that is characteristic of a certain category or a term that tends to be unclear may be registered in a database, and the registered term may be included in a summary.

Image processing may be a super-resolution process that enhances the resolution of an image or a process that reduces the resolution of an image. In addition to, or instead of these processes, image processing may be optimization of contrast, brightness, exposure, and other parameters. Alternatively, a characteristic portion (e.g., a portion of a doll) may be cropped from the image 67, or a background portion of the doll may be trimmed. Cropping or trimming an image corresponds to extracting information. The resolution or parameters may be changed for an image that has been extracted (hereinafter referred to as the extracted image).

For example, when the extracted image (processed information) is generated from the original image 67, a characteristic portion may be extracted using a map model such as an activation map or a saliency map. An activation map can be generated by, for example, applying gradient-weighted class activation mapping (Grad-CAM) to an image input to a CNN model. Then, an activated region (a region indicating a certain category) is cropped, or a non-activated region (a region that does not indicate a certain category) is trimmed. Alternatively, a saliency map may be used to generate processed information by cropping a region having a low saliency score (a region that is likely to be overlooked by a person).

As another option, an image may be cropped based on an aesthetic score map. For example, Grad-CAM is applied to a CNN-based image assessment model, such as Neural Image Assessment (NIMA), to generate a heat map that emphasizes regions of the image according to the aesthetic score. Accordingly, processed information may be generated by cropping a region of the image having a relatively high aesthetic score or trimming a region of the image having a relatively low aesthetic score (a region that tends to be overlooked by a person).

Encoding includes converting different types of data (e.g., category 52, description 53, and image 67) into data that can be compared with each other. Encoding may be performed on processed information. Examples of encoding may include converting item information (e.g., a character string and an image) into distributed representations. For instance, in the first example, the description 53 (original text) and the image 67 may each be converted into a distributed representation. For instance, a known machine learning model 36h (e.g., CNN, FastText, Doc2Vec, Sentence2Vec, Data2Vec, or BERT) may be used to encode a character string. When receiving a character string, the machine learning model 36h outputs a distributed representation of the character string. Encoded data (e.g., distributed representation) is an example of the index 71. An image may be encoded using a known machine learning model 36i (e.g., CNN).

Extracting a portion from item information may include at least one of extracting a portion from a character string that indicates the item information, extracting a character from an image that indicates the item information, cropping or trimming a portion of the image indicating the item information, and extracting audio data or a character string from a moving image.

When a character is extracted from an image, the character is first detected from the image and then the detected character is recognized as a character string. This processing may use a machine learning model 36j that performs character detection and character recognition as separate tasks or a machine learning model 36k that simultaneously performs character detection and character recognition. A character can be extracted using a known machine learning model 36m for optical character recognition (OCR). For example, one shot object detection such as CNN, Faster Region-based CNN (Faster R-CNN), Rotational Region CNN (R2CNN), and You Only Look Once (YOLO) may be employed. Instead, or Fast Oriented Text Spotting (FOTS) may be employed. Alternatively, a known OCR application may be used to extract a character string from an image.

When a character string is extracted from a moving image or audio data, automatic speech recognition (ASR) is performed to recognize audio and convert it into a character string. For example, ASR can be performed using a machine learning model 36n to which a recurrent neural network (RNN), a residual CNN, ContextNet, or a transformer.

The extracted character string or image may be encoded or classified as necessary and compared with the original item information, other item information, or other processed information. For example, the result obtained by classifying the entire image 67 may be compared with the result obtained by classifying the extracted image of that image 67. When different images 67 are registered, the indexing process may be executed for each image 67.

For instance, a character extracted from the image 67 (“The item is a photo.” in FIG. 3) can be used as processed information. In a fourth example, a classification result obtained by encoding and then classifying the extracted character may be compared with a classification result based on other item information, such as the description 53 or processed information (for example, an encoded summary) of the description 53. Alternatively, a character obtained by extracting a characteristic (important) expression (e.g., “a photo of a set of stuffed toys” in FIG. 3) from the description 53 may be encoded.

When the degree of similarity between two distributed representations (two pieces of item information, two indices 71, or two classification results) is greater than or equal to a predetermined threshold value, the two distributed representations may be identified as consistent. In other words, when the similarity between the two distributed representations is less than the threshold value, the item information registered for one item may be identified as unclear.

When three or more distributed representations are obtained and they include two distributed representations that are not similar to each other, the processor 31 may identify these pieces of item information as unclear. For more strict determination, if there is at least one distributed representation having a similarity that is less than the threshold value, the processor 31 may identify these pieces of item information as unclear.

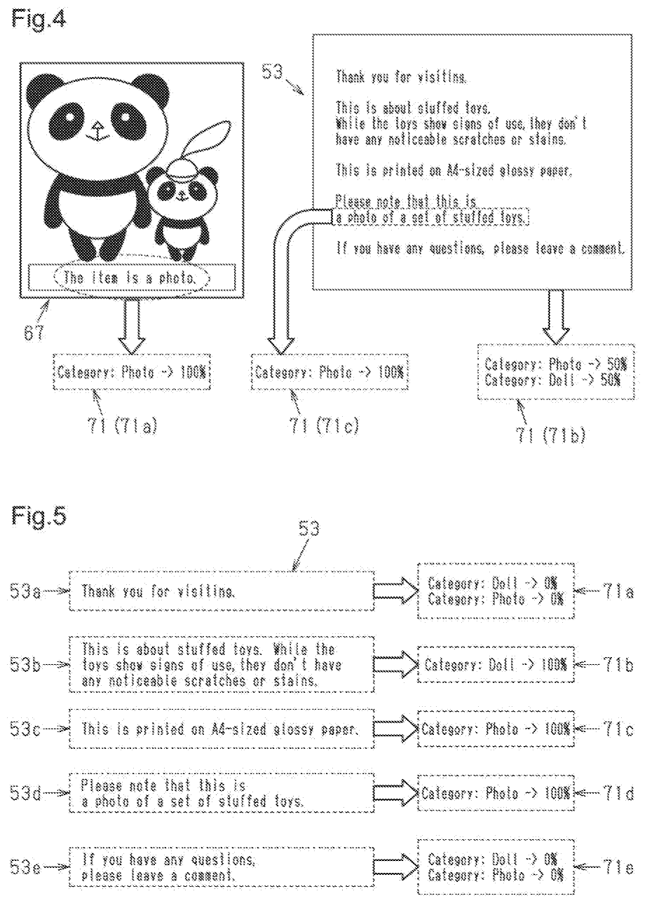

In a fifth example shown in FIG. 4, the first index 71a shows that the probability that the item 17 is a photo is 100% based on the processed information obtained by encoding the characters extracted from the image 67. The second index 71b shows that the probability that the item 17 is a photo is 50% and the probability that the item 17 is a doll is 50% based on the processed information obtained by encoding the description 53. The third index 71c shows that the probability that the item 17 is a photo is 100% based on the processed information obtained by encoding the summary of the description 53. When the three indices 71 (the first index 71a to the third index 71c) are obtained, the processor 31 may identify these pieces of item information as unclear based on the second index 71b, which shows that the probability of being a doll is 50%.

In the identification process, two alternative identification results of “clear” and “unclear” may be simply set. In addition, intermediate identification results (e.g., “generally clear” or “probably unclear”) may be set according to the degree of variations in the probability or the index 71. Alternatively, a degree indicating clarity (e.g., clarity: 1, 2, 3, . . . ) may be employed as an identification result.

As in the sixth example shown in FIG. 5, one piece of item information such as the description 53 may be divided into portions 53a to 53e (e.g., one sentence at a time), and each portion (each sentence) may be encoded to obtain the probability of each portion (each sentence), for example, the first index 71a to the fifth index 71e. In addition, when the probability that one of the first index 71a to the fifth index 71e obtained from one piece of item information is in a category that is different from those of the other indices 71 is greater than or equal to a predetermined threshold value (e.g., 50% or 100%), the processor 31 may identify the item information as unclear.

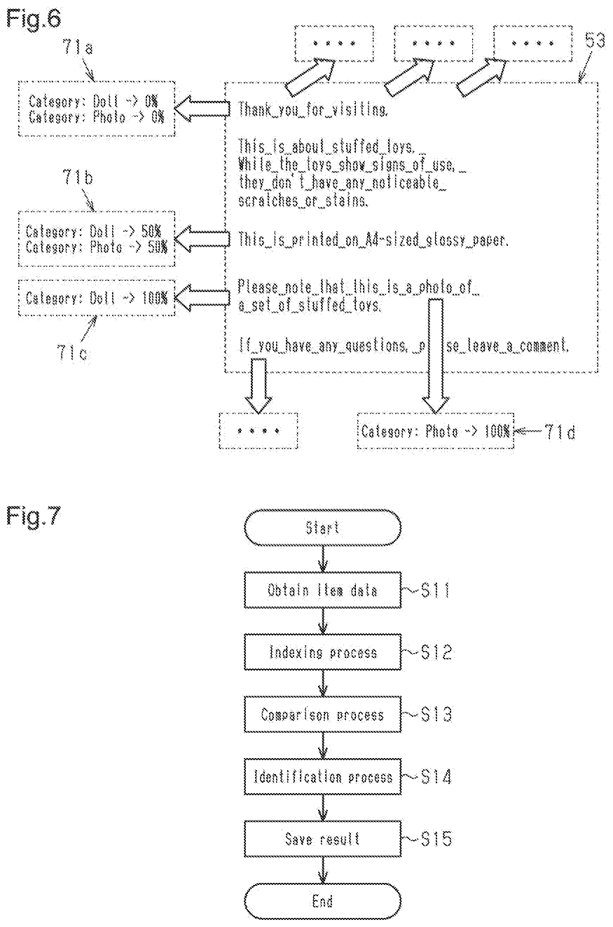

As in a seventh example shown in FIG. 6, one piece of item information (e.g., description 53) may be divided (tokenized) into words (tokens) using tokenization, and each of the divided words may be encoded into a form that can be processed by a computer. Then, the probability (indices 71a, 71b, 71c, . . . ) corresponding to a specific category may be calculated for each word.

Specifically, a unit for dividing a character string may be a sentence or a word. Alternatively, a character string may be divided in a unit such as a paragraph, a section, or a specific number of characters. When the probability of being in a category different from those of the other indices 71 among the indices 71 obtained for each portion is greater than or equal to a threshold value, the processor 31 may identify the item information as unclear. Further, in addition to the probability for each portion, the probability of the entire description 53 may be used as an additional index 71.

A determination method or a determination criterion for performing the identification process may be changed based on specific item information. For example, if the price 68 is greater than a specified threshold value (e.g., a price significantly above the average price for a certain category 52 or attribute), a larger number of indices 71 may be used for comparison, or the criteria for identifying clarity may be made stricter. Alternatively, when there is a category 52 in which the item information tends to be unclear and there is an item 17 corresponding to such a category 52, a larger number of indices 71 may be used for comparison, or the criteria for identifying the item 17 as clear may be made stricter. As another option, the determination method or criterion may be changed according to the attribute 62 of the seller.

When a certain condition is satisfied, an index 71 based on specific item information may be obtained and used as a comparison target. For example, when the number of characters of the description 53 is greater than or equal to a predetermined number, the index 71 based on the processed information of the description 53 may be obtained. Alternatively, when the rating 63 for the seller 15 is lower than a specified level, a larger number of indices 71 may be used for comparison with the item 17 of the seller 15, or the criteria for identifying the item 17 as clear may be made stricter for the item 17 of the seller 15.

Information Processing Executed by Information Processing Device 30

FIG. 7 illustrates an example of information processing executed by the information processing device 30 in order to identify whether registered item information is unclear. The information processing device 30 executes the processes of steps S11 to S15 for each of the items 17 registered in the electronic commerce platform. The information processing may be executed each time an item 17 is registered, or may be consecutively executed for items 17 in each category 52 or at a predetermined point in time.

In step S11, the processor 31 obtains the item data 27 from the server 20 and stores it in the memory 32 as the item data 37. In step S12, for one item 17, the processor 31 executes the indexing process for one or more pieces of item information in order to obtain an index 71 that is used to compare the one or more pieces of item information. The item information for which the indexing process is executed in step S12, the content of the indexing process, and the number of obtained indices 71 may be changed according to conditions (e.g., the item 17, the category 52, or the registered item information).

In step S13, the processor 31 executes the comparison process that compares at least two of the one or more indices 71 obtained in step S12 with each other. In more detail, the processor 31 determines whether comparison targets match each other.

In step S14, the information processing device 30 executes the identification process based on the comparison result in step S13. For instance, when indices 71 do not match each other or when a requirement related to the indices 71 is not satisfied (e.g., when the probability of being a certain category is less than a threshold value), the processor 31 identifies the item information registered for the item 17 as unclear. When the indices 71 match each other or when the requirement related to the indices 71 is satisfied, the processor 31 identifies the item information registered for the item 17 as clear. When the index 71 is a category, instead of or in addition to the fact that the item information is clear, the processor 31 may identify the item 17 as belonging to the category obtained as the index 71.

In step S15, the processor 31 stores at least the result of the identification process in the memory 32, and terminates the process. In step S15, the processor 31 may further store, in the memory 32, the index 71 obtained in step S12 and the result of the comparison process in step S13.

Operation of Present Disclosure

When multiple pieces of item information are registered for one item 17, it is challenging to determine whether all of the pieces of item information are correct. For example, it is difficult for a third party (e.g., the administrator of the commerce website) to check whether the registered image 67 is a photo of the registered item 17. Similarly, when multiple pieces of item information are inconsistent with each other, it is difficult to determine which piece of item information is incorrect. There are various patterns of defects related to item information. Thus, it takes a lot of time and effort to determine all of the determination criteria. In addition, when the types of data related to multiple pieces of item information are different from each other, they cannot be directly compared with each other.

To solve these problems, the information processing device 30 obtains indices 71 by indexing multiple pieces of item information. In this case, even if the types of data related to item information are different from each other, indices comparable with each other are obtained by executing a process such as encoding or classification. Further, the information processing device 30 obtains the index 71 from each of the original item information and processed information by processing one piece of item information.

Further, the information processing device 30 checks at least whether the item information is unclear by comparing indices 71 with each other. That is, even if the information processing device 30 cannot identify what kind of defect exists in which item information, the information processing device 30 identifies or estimates whether the item information is unclear through automated processing.

Since the indexing process can be executed through data processing using the machine learning model 36, the need for manual individual check is eliminated. Executing the indexing process allows the machine learning model 36 corresponding to the type of data to be selected. Thus, the information processing device 30 can cope with various pieces of item information.

By checking whether the item information is unclear, various measures can be taken to correct the unclear information. For example, by manually checking only the item information identified as unclear, considerably less effort can be used than checking all pieces of item information manually. Further, if the patterns related to information defects can be recognized by such a check, an additional determination method for each pattern may be established. Such measures enhance the reliability and clarity of registered information in a commerce website.

### Advantages of Present Disclosure

The present disclosure has the following advantages.

(1) By using the information processing device 30, the ambiguity of the item information related to an item 17 through automated processing can be checked.

(2) As in the third example, the ambiguity of item information can be checked by comparing the first index 71a obtained from one piece of original item information with the second index 71b obtained from the processed information of the item information. Thus, the comparison process can be executed using the indices 71 obtained from one piece of item information.

(3) As in the first example, different indices 71 can be obtained from pieces of item information. By comparing the indices 71 with each other, the ambiguity of the item information can be checked.

(4) By processing item information, a greater variety of information that is different from original item information can be obtained. Further, different indices 71 can be obtained from the original item information and its processed information.

(5) By encoding item information, different types of data can be compared with each other.

(6) By summarizing character strings, the original item information (e.g., description 53) can be converted into a more characteristic expression that is more noticeable when read by a user (e.g., purchaser 16).

(7) By processing the image 67, it can be converted into a more characteristic image that is more noticeable when read by a user (e.g., purchaser 16).

(8) By extracting a portion from item information (e.g., an image or a character string), a more characteristic portion of the item information can be extracted. This allows for a more accurate check.

(9) By extracting a portion from a character string, an index 71 that focuses on a more characteristic portion (e.g., a word) can be obtained.

(10) By extracting characters from the image 67, the index 71 can be obtained based on character information included in the image 67.

(11) By cropping or trimming a portion of the image 67, the index 71 can be obtained based on a more characteristic portion.

(12) By setting the index 71 to the category of the item 17, different types of item information can be compared with each other. In addition, the calculation amount of the indexing process can be adjusted by changing the granularity of classification.

(13) By setting the index 71 to the probability that the item 17 belongs to a certain category, it can be quantitatively determined whether the item information is unclear by comparing the probability with a threshold value.

(14) Different types of data included in data fields can be compared with each other by executing the indexing process including encoding.

(15) By using one or more machine learning models 36, the indexing process can be executed similarly to human reasoning. In addition, by combining the machine learning models 36, the indexing process can be executed for different types of data.

The present embodiment may be modified as follows. The present embodiment and the following modifications can be combined as long as they remain technically consistent with each other.

The index 71 may be the probability of being a certain target (e.g., a brand, an article, a type, an attribute, an attribute value, or a combination thereof related to a certain item 17, or a character used as a motif).

The index 71 may be the degree of similarity. For example, the indexing process may vectorize multiple pieces of item information and determine which category the item information belongs to based on the cosine similarity between the pieces of item information. Alternatively, the similarity to a value (correct answer data) obtained by indexing a certain target (e.g., a brand, an article, a type, an attribute, an attribute value, or a combination thereof related to a certain item 17, or a character used as a motif) may be used to determine the category of the indexed item information.

The category 52 is not limited to item information registered by the seller 15. Instead, the category 52 may be a data field identified by the information processing device 30 and generated based on a classification result. Alternatively, when the category 52 is not registered by the seller 15, the data of the category 52 may be generated based on a classification result that is obtained by the information processing device 30. As another example, when the registered item information is unclear, the category 52 registered by the seller 15 may be corrected based on the identified classification result.

The aspects understood from the above embodiment and the modifications are as follows.

[Aspect 1] An information processing device used for an electronic commerce platform, the information processing device including one or more processors and one or more memories, where
at least one of the one or more memories stores item data related to items registered in the electronic commerce platform,
the item data includes data sets,
the data sets each include data fields registered for one of the items,
the data fields each include item information related to the one of the items, and
at least one of the one or more processors is configured to execute an indexing process for one or more pieces of item information to obtain an index used to compare the one or more pieces of item information with each other.

This configuration allows indices to be obtained from one piece of item information and allows an index to be obtained from each of multiple pieces of information. Accordingly, item information can be compared by obtaining indices from item information.

[Aspect 2] The information processing device according to aspect 1, where
the indexing process includes:
   obtaining a first index associated with the one of the items based on one piece of item information;
   generating processed information by processing the one piece of item information; and
   obtaining a second index associated with the one of the items based on the processed information, and
at least one of the one or more processors is configured to execute a comparison process that compares the first index with the second index.

This configuration allows an index to be obtained from one piece of item information and its processed information. Thus, indices can be obtained from one piece of information. After executing the comparison process, the processor may execute the identification process based on a comparison result in the comparison process. When the first index does not match the second index, the identification process may identify the item information related to the indexing be unclear.

[Aspect 3] The information processing device according to aspect 1, where
the data fields include a first data field and a second data field,
item information included in the first data field is referred to as first item information and item information included in the second data field is referred to as second item information,
the indexing process includes:
   obtaining a first index associated with the one of the items based on the first item information; and
   obtaining a second index associated with the one of the items based on the second item information, and
at least one of the one or more processors is configured to execute a comparison process that compares the first index with the second index.

This configuration allows an index to be obtained from each of multiple pieces of item information. Thus, the indices obtained through the indexing process are used to compare different types of item information with each other through automated processing. After executing the comparison process, the processor may execute the identification process based on a comparison result in the comparison process. When the first index does not match the second index, the identification process may identify the item information related to the indexing be unclear.

[Aspect 4] The information processing device according to aspect 3, where
the indexing process includes processing the item information to generate processed information, and
at least one of the first index and the second index is obtained based on the processed information.

This configuration allows an index to be obtained from one piece of item information and its processed information. Thus, indices can be obtained from one piece of item information.

[Aspect 5] The information processing device according to any one of aspects 2 to 4, where the processing the item information includes one or more of encoding the item information, summarizing a character string that indicates the item information, processing an image that indicates the item information, and extracting a portion from the item information.

This configuration allows a variety of processed information through encoding, summarizing, image processing, or extracting. By performing appropriate processing based on the original item information, an index that represents characteristics more succinctly than the original item information can be obtained.

[Aspect 6] The information processing device according to aspect 5, where the extracting includes at least one of extracting a portion from the character string that indicates the item information, extracting a character from the image that indicates the item information, and cropping or trimming a portion of the image that indicates the item information.

In this configuration, an index that represents characteristics more succinctly than the original item information can be obtained by extracting a characteristic portion from the character string. By extracting a character from an image, the type of data that is different from that of the original item information can be obtained. By cropping a characteristic portion from an image, an index that represents characteristics more succinctly than the original item information can be obtained. By trimming an uncharacteristic region (e.g., background) from an image, a more characteristic portion can be preserved. Accordingly, an index that represents characteristics more succinctly than the original item information can be obtained.

[Aspect 7] The information processing device according to any one of aspects 1 to 6, where
the index is a category defined for classifying the items, and
obtaining the index includes classifying one of the items based on the item information.

In this configuration, various type of item information can be set to indices comparable with each other through automated processing by classifying the information into specified categories.

[Aspect 8] The information processing device according to any one of aspects 1 to 6, where
the index is a probability that the items are in a certain category, and
the indexing process includes calculating a probability that one of the items corresponds to the certain category.

In this configuration, by calculating the probability that one item that is in a certain category for each of various types of item information or processed information, those probabilities can be compared with each other. This allows one to determine the extent to which multiple indices match each other through automated processing.

[Aspect 9] The information processing device according to any one of aspects 1 to 8, where
the data fields include types of data that are different from each other, and
the types of data include one of an attribute and an attribute value for the attribute, a character string, an image, and a numerical value.

In this configuration, by indexing different types of data, multiple pieces of item information can be compared with each other through automated processing.

[Aspect 10] The information processing device according to any one of aspects 1 to 9, where the data fields include one or more of a title, a size, a brand, a condition, a description, an image, and a category that are related to the item.

In this configuration, even if the data fields registered for each item are not standardized, the ambiguity of the item information for that item can automatically checked by indexing one or more data fields.

[Aspect 11] The information processing device according to any one of aspects 1 to 10, where the data fields include one or more of a profile of a seller of the item, a rating for the seller, a comment on the seller, a registration date of the seller, and an IP address of the seller.

This configuration allows the ambiguity of item information to be automatically checked based on the data fields related to a seller who sells each item. As a result, credit information about each seller can be obtained.

[Aspect 12] The information processing device according to any one of aspects 1 to 11, where at least part of the indexing process is executed using one or more machine learning models.

In this configuration, the use of one or more machine learning models allows the indexing process to be executed similarly to human reasoning. In addition, by combining the machine learning models, the indexing process can be executed for different types of data.

[Aspect 13] The information processing device according to any one of aspects 1 to 12, where
the index is a category defined for classifying the items,
the indexing process includes obtaining two or more classification results by classifying one of the items two or more times based on different types of information, and
at least one of the one or more processors is configured to execute an identification process based on the two or more classification results, the identification process including:
   identifying item information registered for the one of the items as unclear when the two or more classification results do not match each other; and
   identifying the category of the one of the items based on the classification results when the two or more classification results match each other.

In this configuration, the identification of whether the item information registered for one item is ambiguous can be made based on two or more classification results. When the two or more classification results match each other, the category of the item can be identified.

[Aspect 14] The information processing device according to any one of aspects 1 to 12, where
the index is a category defined for classifying the items,
the data fields include the category of the items,
the indexing process includes obtaining a classification result by classifying one of the items based on the item information, and
at least one of the one or more processors is configured to execute an identification process based on the category and the classification result, the identification process including:
   identifying item information registered for the one of the items as unclear when the category and the classification result do not match each other; and
   identifying the category of the one of the items based on the classification result when the category and the classification result match each other.

In this configuration, the identification of whether the item information is unclear can be made based on its category, which is a type of item information, and based on a classification result of item information that is different from the category.

[Aspect 15] An information processing method executed by an information processing device used in an electronic commerce platform, the information processing method including:
obtaining item data related to items registered in the electronic commerce platform, the item data including data sets, the data sets each including data fields registered for one of the items, and the data fields each including item information related to the one of the items; and
executing an indexing process for one or more pieces of item information to obtain an index used to compare the one or more pieces of item information with each other.

[Aspect 16] A program executed by an information processing device used in an electronic commerce platform, where the program causes one or more computers to:
obtain item data related to items registered in the electronic commerce platform, the item data including data sets, the data sets each including data fields registered for one of the items, and the data fields each including item information related to the one of the items; and
execute an indexing process for one or more pieces of item information to obtain an index used to compare the one or more pieces of item information with each other.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An information processing device used for an electronic commerce platform, the information processing device comprising one or more processors and one or more memories, wherein
at least one of the one or more memories stores item data related to items registered in the electronic commerce platform,
the item data includes data sets,
the data sets each include data fields registered for one of the items,
the data fields each include item information related to the one of the items, and
at least one of the one or more processors is configured to execute an indexing process for one or more pieces of item information to obtain an index used to compare the one or more pieces of item information with each other.

2. The information processing device according to claim 1, wherein
the indexing process includes:
obtaining a first index associated with the one of the items based on one piece of item information;
generating processed information by processing the one piece of item information; and
obtaining a second index associated with the one of the items based on the processed information, and
at least one of the one or more processors is configured to execute a comparison process that compares the first index with the second index.

3. The information processing device according to claim 1, wherein
the data fields include a first data field and a second data field,
item information included in the first data field is referred to as first item information and item information included in the second data field is referred to as second item information,
the indexing process includes:
obtaining a first index associated with the one of the items based on the first item information; and
obtaining a second index associated with the one of the items based on the second item information, and
at least one of the one or more processors is configured to execute a comparison process that compares the first index with the second index.

4. The information processing device according to claim 3, wherein
the indexing process includes processing the item information to generate processed information, and
at least one of the first index and the second index is obtained based on the processed information.

5. The information processing device according to claim 4, wherein the processing the item information includes one or more of encoding the item information, summarizing a character string that indicates the item information, processing an image that indicates the item information, and extracting a portion from the item information.

6. The information processing device according to claim 5, wherein the extracting includes at least one of extracting a portion from the character string that indicates the item information, extracting a character from the image that indicates the item information, and cropping or trimming a portion of the image that indicates the item information.

7. The information processing device according to claim 1, wherein
the index is a category defined for classifying the items, and
obtaining the index includes classifying one of the items based on the item information.

8. The information processing device according to claim 1, wherein
the index is a probability that the items are in a certain category, and
the indexing process includes calculating a probability that one of the items corresponds to the certain category.

9. The information processing device according to claim 1, wherein
the data fields include types of data that are different from each other, and
the types of data include one of an attribute and an attribute value for the attribute, a character string, an image, and a numerical value.

10. The information processing device according to claim 1, wherein the data fields include one or more of a title, a size, a brand, a condition, a description, an image, and a category that are related to the item.

11. The information processing device according to claim 1, wherein the data fields include one or more of a profile of a seller of the item, a rating for the seller, a comment on the seller, a registration date of the seller, and an IP address of the seller.

12. The information processing device according to claim 1, wherein at least part of the indexing process is executed using one or more machine learning models.

13. The information processing device according to claim 1, wherein
the index is a category defined for classifying the items,
the indexing process includes obtaining two or more classification results by classifying one of the items two or more times based on different types of information, and
at least one of the one or more processors is configured to execute an identification process based on the two or more classification results, the identification process including:
identifying item information registered for the one of the items as unclear when the two or more classification results do not match each other; and
identifying the category of the one of the items based on the classification results when the two or more classification results match each other.

14. An information processing method executed by an information processing device used in an electronic commerce platform, the information processing method comprising:
obtaining item data related to items registered in the electronic commerce platform, the item data including data sets, the data sets each including data fields registered for one of the items, and the data fields each including item information related to the one of the items; and
executing an indexing process for one or more pieces of item information to obtain an index used to compare the one or more pieces of item information with each other.

15. A computer-readable storage medium that stores a program, the program being executed by an information processing device used in an electronic commerce platform, wherein
the program is configured to cause one or more computers to:
obtain item data related to items registered in the electronic commerce platform, the item data including data sets, the data sets each including data fields registered for one of the items, and the data fields each including item information related to the one of the items; and
execute an indexing process for one or more pieces of item information to obtain an index used to compare the one or more pieces of item information with each other.
